(19) United States
(12) Patent Application Publication
(10) Pub. No.: US 2005/0144859 A1
(43) Pub. Date: Jul. 7, 2005

(54) Construction kit

(75) Inventor: Haggai Paz, Zoran (IL)

Correspondence Address: BROWDY AND NEIMARK, P.L.L.C.;624 NINTH STREET, NW, SUITE 300, WASHINGTON, DC, 20001-5303, US

(73) Assignee: Keter Plastic Ltd., Herzelyia (IL)

(21) Appl. No.: 11/001,639

(22) Filed: Dec. 2, 2004

Related U.S. Application Data
(63) Continuation-in-part of application No. 09/983,755, filed on Oct. 25, 2001, now Pat. No. 6,843,025.

(51) Int. Cl. E04H 1/00; E04C 1/00

(52) U.S. Cl. 52/79.1

(57) ABSTRACT

A construction kit by means of which a do-it-yourselfer can erect a stable, strong structure whose predetermined geometry is maintained even when the structure is subjected to stresses. The kit includes a plurality of beams, a set of rectangular panels and two end frames. To assemble the structure, the beams are arranged to bridge the end frames and to snap-lock or screw onto the corners thereof to form a skeleton in which the beams are in parallel relation. The beams are profiled to form internal tracks for slidably receiving the panels, each panel being supported between a pair of adjacent beams to create a wall of the structure.

The present invention is a continuation-in-part of U.S. Ser. No. 09/983,755.

### FIELD OF THE INVENTION

This invention relates generally to construction kits by means of which a do-it-yourselfer can erect a stable structure, and in particular to a kit of this type whose components can be assembled to create a walled structure whose pre-determined geometry is maintained even when the structure is subjected to stresses.

### BACKGROUND OF THE INVENTION

### Status of Prior Art

A conventional article of furniture such as a cabinet whose components are made of wood, plastic or composite materials, is usually assembled at a factory by means of screws, bolts or other fasteners, or by gluing the joints. Once the cabinet is finished and in condition to be sold, it must be crated and shipped to a retailer. When the retailer sells the cabinet, he must snip it in its finished state to his customer.

The cost of crating and shipping finished articles of furniture may in some instances approach its selling price. And the selling price cannot be low because it must cover the cost of assembling the article.

It is for these reasons that a large share of the furniture market has now been taken over by so-called “knock-down” furniture, such as those sold internationally by the IKEA furniture chain. What the consumer buys is not a finished article of furniture but a kit containing all of its components accompanied by instructions explaining to a do-it-yourselfer what must be done to assemble the components. Also included in the kit are screws and other fasteners necessary to join the components together as well as the tools for this purpose such as a wrench and screwdriver.

But a do-it-yourselfer is an amateur, not a professional craftsman, and when assembling a knock-down piece, the resultant structure may be somewhat misshapen and unstable.

One difficulty a do-it-yourselfer is likely to encounter is when erecting a structure having wall panels that must be mounted on frames. If the frames erected by the do-it-yourselfer are not quite rectangular, he will find it difficult to attach rectangular panels to these frames. Thus if a frame is provided with holes to receive screws for mounting a panel, and the panel is provided with matching holes, these panel holes will be out of registration with those in the frame should the frame not be perfectly rectangular.

A more troublesome aspect of an article of furniture assembled from a kit of parts is the so-called parallelogram effect. When a rectangular frame defined by parallel end beams attached to parallel side beams has a panel secured thereto is subjected to stresses, as are most articles of furniture, this may give rise to the parallelogram effect in which the end beams assume an acute angle with respect to the side beams.

To avoid this undesirable effect it is the common practice to reinforce the frame with guy wires extending diagonally in an X-formation from the four corners of the frame to resist its deformation. These guy wires are not only unsightly but they add to the cost of the do-it-yourself article and to some degree defeat its purpose which is to provide the consumer with a kit by which he can assemble an article that will be significantly less expensive than a pre-assembled, factory-made article.

### SUMMARY OF THE INVENTION

In view of the foregoing, this invention is concerned with providing a kit which makes it possible for a typical do-it-yourselfer to erect a structure that is stable and strong and which maintains a predetermined geometry even when the article is subjected to stresses, such as for example originating from wind loading, or mechanical forces such as people or equipment leaning on the structure. Thus if the structure to be erected is designed to have a parallelepiped geometry with a rectangular cross-section, then even when erected by an unskilled do-it-yourselfer it will not have a trapezoidal or other non-rectangular cross-section but will have the proper cross-section.

Among the significant advantages of the invention are the following:
1st. The components which together make up the article of furniture to be assembled by a do-it-yourselfer are easily joined together so that it takes relatively little time to erect the structure,
2nd. The structural beams included in the kit from which the skeleton of the structure is created are profiled to define internal tracks for accommodating the panels forming the walls of the structure,
3rd. The structure is highly-resistant to the parallelogram effect and require no guy wires or other reinforcing expedients to prevent this undesirable effect,
4th. The do-it-yourself kit is relatively inexpensive and can be mass-produced at low cost.

Briefly stated, these objects are accomplished in a construction kit in accordance with the invention by means of which a do-it-yourselfer can quickly erect a stable and strong structure, such as a dog house, whose predetermined geometry is maintained even when the structure is heavily stressed. The kit includes a plurality of beams, two end frames and rectangular panels which when assembled create the desired structure.

To assemble the structure, the beams are arranged to bridge the end frames and to snap-lock or screw onto the corners thereof to form a skeleton in which the beams are in parallel relation. The beams are profiled to form internal tracks for slidably receiving the panels, each panel being supported between a pair of adjacent beams to create the walls of the structure. To disassemble the structure, it is only necessary to release the beam snap locks or remove the screws. In contrast, some prior art structures require a plurality of nails to stabilize the structure, in some cases by effectively bonding a back panel to the frame by using a large number of nails nailed in close proximity one to another so that the nails act as a permanent joint.

The invention also presents a departure from regular conceptualizations of frames, in which prior art frames are conceptualized as being major load-carrying members, and for rigidly supporting panels, which are less important as load carrying members. Accordingly, such prior art frames have necessitated being strong and rigid structures, capable of maintaining their relative geometrical and spatial configurations in the absence of the panels that are to be mounted therein. In the present invention, the panels are the major load-carrying members, and the frames, on the other hand, have a major role in connecting panels to other panels or structures. While enabling transmitting of loads between such panels and structures, the frame itself does not support major loads. This is accomplished by holding the panels within the frames in a loose manner such that substantially no shear loads are transmitted between the frame and the panels, but rather only compression loads between particular edge members of the frame and the panel edge onto which the connector is abutting. Accordingly, the frames of the present invention do not even require to maintain their spatial configurations when not accommodating panels, and at least some parts of the frames are not required to support compression loads.

Thus, in accordance with the invention a connector is provided for connecting a panel having a plurality of edges to a structure, and also to a load bearing structure, comprising a panel having a plurality of edges and accommodated in such a connector. The connector is in the form of a frame comprising at least a corresponding plurality of edge connectors joined one to another such as to enable said frame to circumscribe said edges of a said panel,
wherein at least two of said edge connectors each comprise a channel sized for loosely receiving corresponding edges of a said panel such as to trap a said panel within said frame and such that substantially no shear stresses are transmittable between said frame and a panel that may be accommodated therein; and
wherein at least one said edge connector is adapted for connection to a said structure.

The connector is particularly adapted for enabling a substantially rectangular panel to be connected to a structure, comprising:
first and second opposed said edge connectors, each having a channel for slidingly receiving first and second opposed edges, respectively, of a said panel;
third and fourth opposed edge connectors adapted to be aligned with third and fourth opposed edges of said panel;
wherein said first and second edge connectors are orthogonally joined to said third and fourth edge connectors to form said frame;
wherein at least said first and second edge connectors are adapted for connection to a said structure.

The said first and second edge connectors are typically orthogonally joined to said third and fourth edge connectors by means of at least one pin at each of the corners of said frame, and the pins allow pivotal movement between adjacent said edge connectors. Alternatively, the first and second edge connectors are orthogonally joined to said third and fourth edge connectors by means of at least one screw screwed at each of the corners of said frame.

At least one of said first edge connector and said second connector may form part of another said frame and comprise a further said channel for accommodating a corresponding edge of another said panel. Additionally or alternatively, at least one of said first edge connector and said second connector are adapted for connecting said frame directly to a sheet of material.

The channels are typically substantially of rectangular cross-section and sized to provide a lateral clearance of about 1 mm between a said panel accommodated in said frame and said channel.

The third and fourth edge connectors may be adapted for resisting tensile loads, with accompanying strains, less than about 5 Kg force per 100 m×100 mm area, for loads within the elastic limit thereof; at the same time, the third and fourth edge connectors may be incapable of resisting compressive loads in direction parallel to said edges.

Typically, the mechanical properties of said edge connectors and/or the manner in which said edge connectors are joined to form said frame, are such that the frame, in the absence of a said panel accommodated therein, is able to support buckling loads which are no greater than x % of corresponding buckling loads of said frame when accommodating a said panel therein, wherein x % is between about 0.5% and 20%, and typically less than about 5%.

Typically, the mechanical properties of said edge connectors, and/or the manner in which said edge connectors are joined to form said frame, are such that the frame, in the absence of a said panel accommodated therein, has a stiffness no greater than y % of the corresponding stiffness of said frame when accommodating a said panel therein, wherein y % is between about 0.5% and 20%, and typically less than about 5%.

The panel is adapted to support a major proportion of loads applied to said structure, that is more than 50% of the load, typically 90% to 99% of the load, and the frame is adapted to support a minor proportion of said loads, that is less than 50% of the loads, typically 1% to 10% of the loads, said loads being applied substantially in a plane co-planar with said panel.

According to the invention, a plurality of said panels may be interconnected via at least some of said edge connectors.

The frames are typically made from a molded material, which may be blow molded or injection molded for example, such as for example a suitable plastic material. The panel are typically made from an extruded material, such as for example aluminium or alloys including alloys of aluminium, or a suitable plastic material.

The present invention also relates to a method for designing a load bearing structure having at least one panel and at least one frame circumscribing said panel, comprising:

designing said at least one panel member for bearing a majority of a load to be supported by said structure;

for each said panel, designing said frame for trapping said panel therein and for bearing a minority of said load, wherein substantially no shear stresses are transmittable between said panel and said frame.

Thus, the present invention enables substantially rectangular panels to be cut to any desired length from a so-called endless panel of a particular width and cross-section, as is typically produced by extrusion, and for such panels to be connected to other structures, including other similar panels, without having to modify the panels at all. In other words, no connection features are required to be molded or otherwise created in the panels, which are therefore cheaper to produce than otherwise. Further, no special edge features are required at the transverse edges (i.e., the “cut” edges) of the panels, thus enabling such panels to be produced by extrusion and cut to length, rather than cast or individually molded. The extrusion process used for such panels enables substantially hollow panels comprising strengthening webs to be produced as integral structures from plastics and the like, or even metals, providing stronger load bearing structures than may be produced using the same amount of material in a molding process. The connector of the invention allows the panel to bear most of the loads, and the connector is adapted for holding the panel to a structure such that loads can be transmitted between the panel and the structure.

### BRIEF DESCRIPTION OF THE DRAWINGS

For a better understanding of the invention as well as other objects and features thereof, reference is made to the annexed drawing wherein:

FIG. 1 is a perspective view of a structure erected by assembling the components of a kit in accordance with a first embodiment of the invention;

FIG. 2 shows the same structure with one end frame removed to expose the interior of the structure;

FIG. 3 illustrates one frame of the structure and a beam joined thereto which supports a wall panel at right angles to the frame;

FIG. 4 is a magnification of a detail of the structure encircled in FIG. 3;

FIG. 5 is a transverse section taken through one of the beams;

FIG. 6 shows the profiled beam when loaded with panels of different thicknesses;

FIG. 7 illustrates the latch of a snap-lock at the corner of a frame included in the structure;

FIG. 8 shows how the beam latches onto the frame;

FIG. 9 illustrates a second embodiment of invention in which the structure is a dog house;

FIG. 10 shows the dog house structure without its front and rear end frames;

FIG. 11 shows the structure with its end frames detached therefrom; and

FIG. 12 illustrates a third embodiment of the invention.

### DETAILED DESCRIPTION OF THE INVENTION

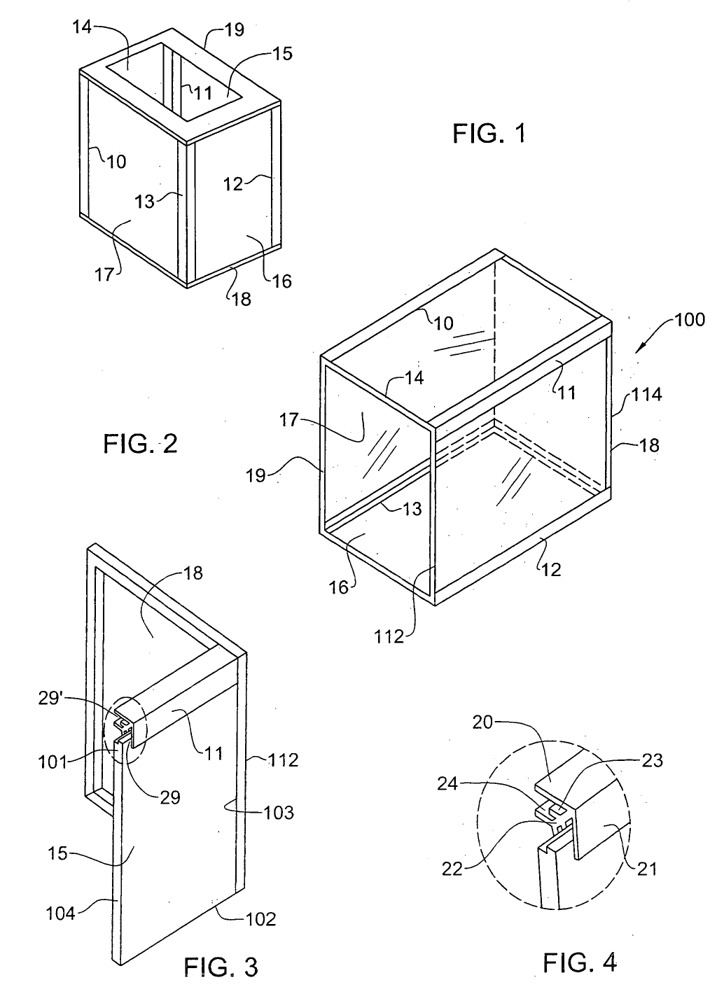

Referring now to FIGS. 1 and 2, shown in these figures is a structure created by assembling the components of a construction kit in accordance with a first embodiment of the invention. The structure illustrated in these figures is a plastic container having a parallelepiped geometry, with a closed bottom wall and an open to wall. It is to be understood, however, that this simple structure is by way of example only, and that more complex structures can be erected by means of a kit having a greater number of components.

The components of the kit from which the container is assembled are the following:
(1) a set of four like structural beams 10, 11, 12 and 13,
(2) a set of four like rectangular panels 14, 15, 16 and 17 to form the walls of the structure,
(3) a closed rectangular end frame 18,
(4) an open rectangular end frame 19.

To assembly the structure, beams 10 to 13 are at their opposite ends snap-locked to the respective four corners of end frames 18 and 19 so as to bridge these frames and thereby create the skeleton of the structure in which the panels are trapped between adjacent parallel beams to form four side walls. All components of the kit are preferably molded of synthetic plastic material of high-strength, such as polypropylene or polyethylene. In practice, the beams may be formed of extruded aluminum or any structural material that can withstand the required tensile stresses, for the particular application of the beam, without stretching plastically or breaking.

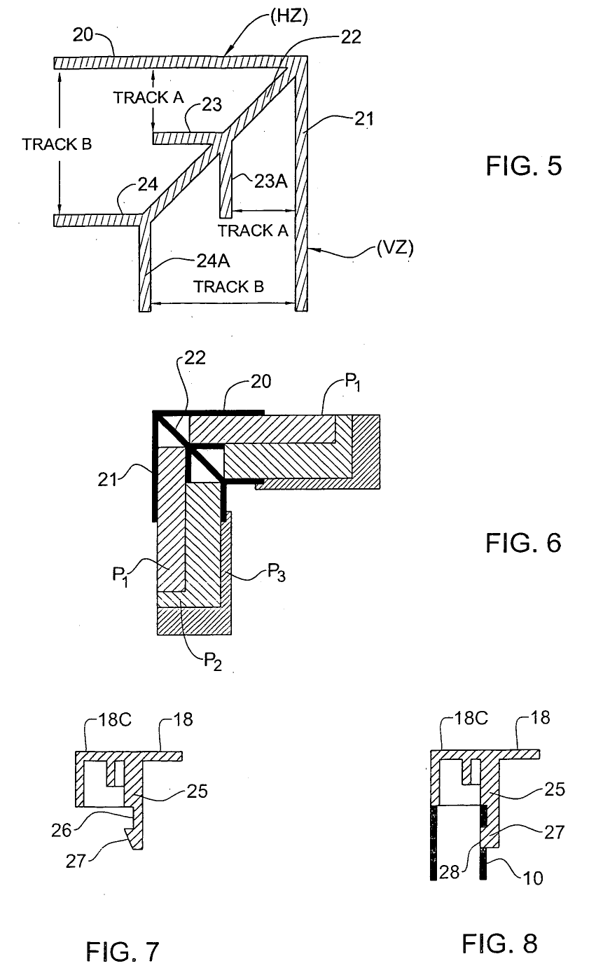

Each beam, as shown in FIGS. 3 to 6, is profiled to define outer slats 20 and 21 at right angles to each other, and a diagonal slat 22 extending from the apex of the right angle to divide the beam into a horizontal zone HZ and a vertical zone VZ. Projecting from diagonal slat 22 at an intermediate position in horizontal zone HZ is a narrow ledge 23 which is parallel to outer slat 20. This ledge creates a narrow track A to accommodate a thin sidewall panel P1. Projecting into horizontal zone HZ from the free end of diagonal slat 22 is a broad ledge 24 which is parallel to outer slat 21 to create a wide track B. This track is dimensioned to accommodate a thicker panel P2 as shown in FIG. 6.

Should it be necessary to provide a very thick wall panel, such as panel P3 shown in FIG. 6, then in order for panel P3 to be accommodated, its edge must be stepped, the lowest step fitting into track A, the middle step into track B, and the third step abutting broad ledge 24.

Vertical zone V has corresponding ledges, namely a narrow ledge 23A and a broad ledge 24A to define a narrow track A and a wide track B. When the structure is being assembled, each of the panels 14, 15, 16 and 17 is slidably received in a pair of adjacent parallel beams, the panel going into the horizontal zone of these beams forming a horizontal wall, and the panel going into the vertical zone a vertical wall.

Since the beams are snap locked in the end frames, the panels are entrapped in the beams and act to stabilize the structure. To disassemble the structure, it is only necessary to release the snap locks and thereby separate the beams from the end frames and free the panels from the beams.

FIGS. 7 and 8 illustrate a snap lock in a corner 18C of frame 18. This corner is provided with a flexible latch arm 25 having a notch 26 therein to create a tooth 27. When an end of beam 16 is pushed against corner 18C of frame 18, the tooth 27 in latch arm 25 then snaps into a slot 28 in the beam end to lock the beam to the corner. To release the lock it is only necessary by means of a button (not shown) to push the tooth of the latch out of the slot in the beam.

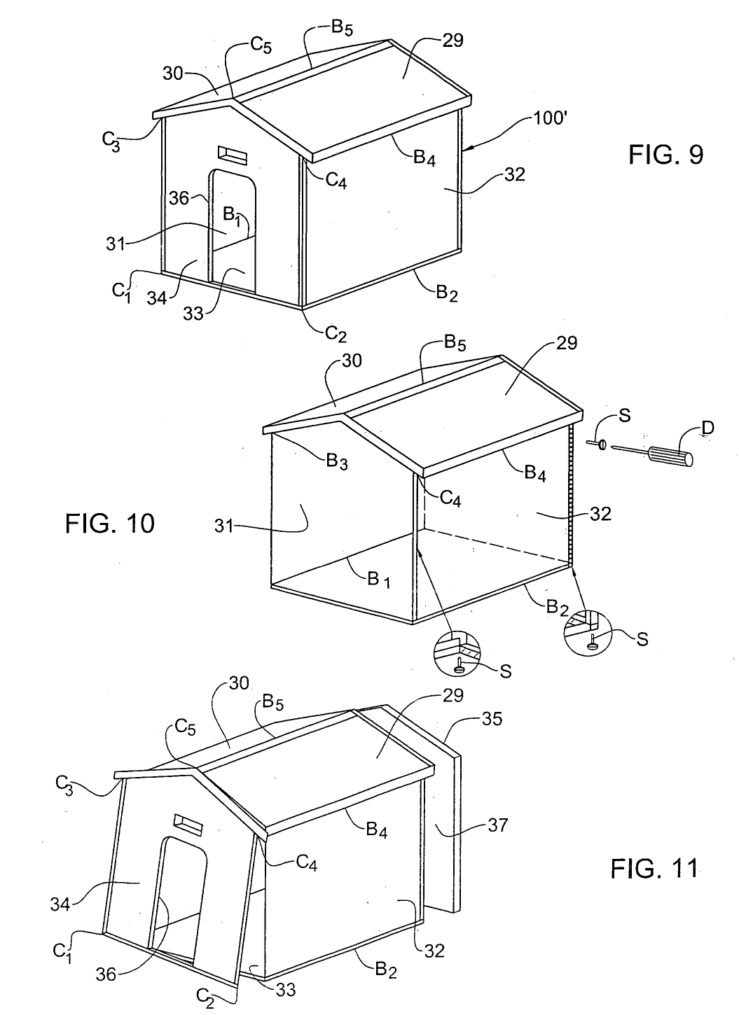

Illustrated in FIGS. 9, 10 and 11 is a dog house in accordance with a second embodiment of the invention assembled by a do-it-yourselfer from a kit of the components. The kit also provides the screws S necessary to assemble the structure and a screw driver D, as shown in FIG. 10. In practice, instead of screws, other types of fasteners or connectors may be used to connect the beams to corners of the end frames.

Included in the dog house structure is a gabled roof whose angled sides are formed by rectangular panels 29 and 30. Panels 31 and 32 define the vertical sidewalls of the structure, and panel 33 the horizontal floor.

Also provided are front and rear end frames 34 and 35 both having the same rectangular-triangular composite geometry imposed therein by the gable design. Front end frame 34 has mounted therein a wall panel having an arched entry 36 to admit the dog into the house. Rear end frame 35 has a blank wall panel 37 mounted therein to close the rear end of the house. All components of the house are molded of polypropylene or other high strength synthetic plastic. Each end frame has five corners C1 to C5, corners C1 to C4 being at the corners of the rectangular section of the frame corner C5 being at the apex of the triangular section.

Five horizontal beams B1 to B5 are provided which bridge the end frames and are attached thereto by screws S or other fasteners. Beam B1 bridges corners C1 of end frames 34 and 35. Beam B2 bridges corners C2, beam B3 bridges corners C3, beam B4 bridges corners C4, and beam B5 bridges corners C5 at the apex of the frames.

Beams B1 to B5 are parallel to each other and in combination with the end frames create the skeleton of the dog house structure. The beams are profiled in the manner previously disclosed in connection with the first embodiment to define internal tracks to slidably receive the panels 29, 30, 31, 32 and 33 which form the walls and floor of the dog house.

Thus floor panel 33 is trapped between beams B1 and B2 at the base of the structure, panel 32 is trapped between beams B2 and B4 to form one vertical side wall, panel 31 is trapped between beams B1 and B3 to form the other vertical side wall. Panel 29 is trapped between apex beam 35 and beam B4 to form one of the inclined roof walls, while panel 30 is trapped between beams B5 and B3 to form the other inclined roof wall.

In each of these embodiments, the panels are each effectively trapped in a frame, and are not fastened or attached to the frame (or a part of skeleton). Rather, the panels are held loosely within the frames (or skeleton), allowing relative sliding movement between the tracks of each individual beam of the frame and the panel. Such a structure is highly resistant to stresses and maintains its predetermined rectilinear geometry. When a stress force is applied to the trapping frames (or to the skeleton) which seeks to produce a parallelogram effect in which the end frames assume an acute angle with respect to the beams attached thereto, this force is transferred to the planar panels trapped between the beams. But the panels will not tolerate the parallelogram effect, for to do so it would be necessary to disrupt the internal structure of the panels. The panels are typically made of high strength, synthetic plastic material, or from any other suitable material suitable material such as for example aluminium, wood, blow molded foams, expanded (reinforced) foams, and so on. Such materials are highly resistant to shear and compressive forces and act therefore to stabilize the structure and to maintain its predetermined rectilinear geometry.

Thus, the trapping frames themselves do not require to be major load carrying members, but rather are only required to provide sufficient tensile support, and at least two opposed beams are required to provide tracks or the like, to enable the panel to be maintained with its periphery enclosed or at least circumscribed by the frame. In other words, the panels are adapted to support a major proportion of loads applied to said structure, while the frames are adapted to support a minor proportion of said loads, said loads being applied substantially in a plane co-planar with said panel. The “plane” of each panel can be defined as an imaginary plane of the panel, typically half-way depthwise between the opposed faces of the panel. By a “majority” it is meant greater than 50%, preferably greater than 60%, more preferably greater than 70%, even more preferably greater than 80% or 90% or 95% or 99% or greater. By a “minority” it is meant less than 50%, preferably less than 40%, more preferably less than 30%, even more preferably greater than 20% or 10% or 5% or 1% or less.

Thus, while the frame on its own may be made from a material and/or of a configuration such that it would easily deform to a parallelogram when subjected to a suitable force along the length of one of its beams, when a suitable load-carrying panel is enclosed by the frame, the combination is, in contrast, able to withstand such forces. As such, the buckling loads, and the elastic modulus, for such a frame are each substantially lower than for the frame/panel combination. Typically, the buckling loads for such a trapping frame may be about x % of the buckling loads for the frame-panel combination, wherein x % is typically about between 30% and 1% or less. Also typically, the stiffness for such a trapping frame may be about y % of the stiffness for the frame-panel combination, wherein y % is typically about between 30% and 1%, or less.

At the same time, the frame itself allows the panel to be structurally connected to other panels, to form a closed structure, for example, such as the box or dog house of the above-described embodiments. In particular, such an arrangement does not require any modifications to be made to the panels themselves, which can then be, for example, simple extruded rectangular panels which can be cut to any desired length. In other words, no modifications to the panels themselves are required for the sake of connection to other panels or other structural members, and no special profiles (such as for example edge profiles) are required for such connections.

Thus, also in accordance with the present invention, a panel connector arrangement comprising a panel and a frame connector, is provided for connecting a panel to another structure, such as other panels for example, in a simple manner, and in a manner such that the panel itself does not require to be of a special profile to engage with a special complementary profile of an edge connector.

For clarification, then, and referring again to FIGS. 1 to 3, the frame connector 100 of the first embodiment comprises said first and second edge connectors 11, 12, respectively, each of which comprises at least one channel 29 for slidingly receiving one or another of opposed edges 101, 102, respectively, of a rectangular panel 15 therein. Referring to FIGS. 4 to 6, the cross-section of the channel 29 does not require to be such as to engage with a panel edge special profile. Rather, channel 29 may be of substantially rectangular cross-section, and may further allow a clearance of about 0.5 mm between each face of the panel and the lip of the channel. Alternatively, a clearance of less than 0.5 mm may be provided, such as for example 0.1 mm or less, or indeed greater than 0.5 mm, such as for example 1 mm or greater. Optionally, the channel comprises said track A, and optionally said track B, depending on the edge configuration of the panel, and having at least sides 21 and 24A for trapping therein the corresponding edge 101 or 102, as already described above. Herein “trapping” refers to the substantial prevention of relative movement between a panel accommodated with respect to said frame, and the frame, in a direction substantially orthogonal to the plane of the panel, or rather one of the faces thereof.

The connector 100 further comprises third and fourth edge members, 112, 114 that are orthogonally connected at the ends thereof to the ends of edge connectors 11, 12 to form a rectangular frame. As illustrated in FIG. 2, for example, the edge members 112, 114 do not require tracks to hold the corresponding edges 103, 104 of the panel therein, since the edge connectors 11, 12 are usually sufficient for this purpose. Rather, the edge members 112, 114 serve to provide a strut arrangement between the edge connectors 11, 12 that can withstand reasonable tensile loads without undue deformation.

The edge connectors 11, 12 are connected to the edge members 112, 114 as already described above, particularly with reference to FIGS. 7 and 8.

The panel 15 is typically a rectangular panel, i.e., of rectangular plan form, having a constant cross-section along a length thereof, and having straight edges, or edge arrangements as described above with respect to FIG. 6, for example.

Accordingly, when a panel 15 is enclosed at its periphery with a frame 100, the edge connectors 11, 12 prevent the frame from coming out of the frame 100, while the edge members 112, 114 keep the edge connectors 11, 12 spaced on from the other at a substantially constant spacing. Thus, any force that may be applied to the frame/panel combination along, say, the longitudinal axis of edge connector 12, is resisted by the panel 15 and edge members 112, 114, which due to the resistance to tensile loads of the latter, do not deform to allow the parallelogram effect to occur in the foresaid combination.

In this embodiment, the frame 100 is adapted for connecting the panel 15 to two other panels 14, 16, and indirectly to a third panel 17 to form a box-like structure. Accordingly, the edge members 112, 114 are each connected, integrally or in any other suitable manner, to a plurality of other similar edge members to form said end frames 18 and 19, respectively. The edge connectors 11, 12 are each adapted to receive a panel edge of a panel, 14, 16 respectively, at approximately 90° to panel 15. The panels 14, 16, an also panel 17, are each trapped by means of two edge connectors and two edge members.

Referring again to FIGS. 9 to 11, a plurality of different frame connectors are illustrated according to the second embodiment. For clarification, one such connector 100′ is adapted for holding side panel 32, and comprises edge connectors B2 and B4, each having internal tracks as described before, and edge members 112′, 114′ comprised in frames 34, 35, respectively. Edge connector B2 is adapted for connecting another panel thereto at about 90°, and thus also forms part of another frame for trapping therein panel 33. Edge connector B4 is adapted for connecting another panel thereto at an angle greater than 90°, and thus also forms part of another frame for trapping therein roof panel 29. Another frame connector 100″ is adapted for holding roof panel 29, and comprises edge connectors B4 and B5, each having internal tracks as described before, and edge members 112″, 114″ comprised in frames 34, 35, respectively. Edge connector B5 is adapted for connecting another panel thereto at and angle greater than 90° corresponding to the roof angle, and thus also forms part of another frame for trapping therein the other roof panel 30. As is already clear, edge connector B4 is adapted for connecting another panel thereto at an angle greater than 90°, and thus also forms part of another frame for trapping therein side panel 32. Another frame connector 100′″ is provide similar to connectors 100′ and 100″, but adapted for holding the floor panel 33.

In this embodiment, adjoining edge members at each end of the dog house are integrally connected to form frames 34 and 35.

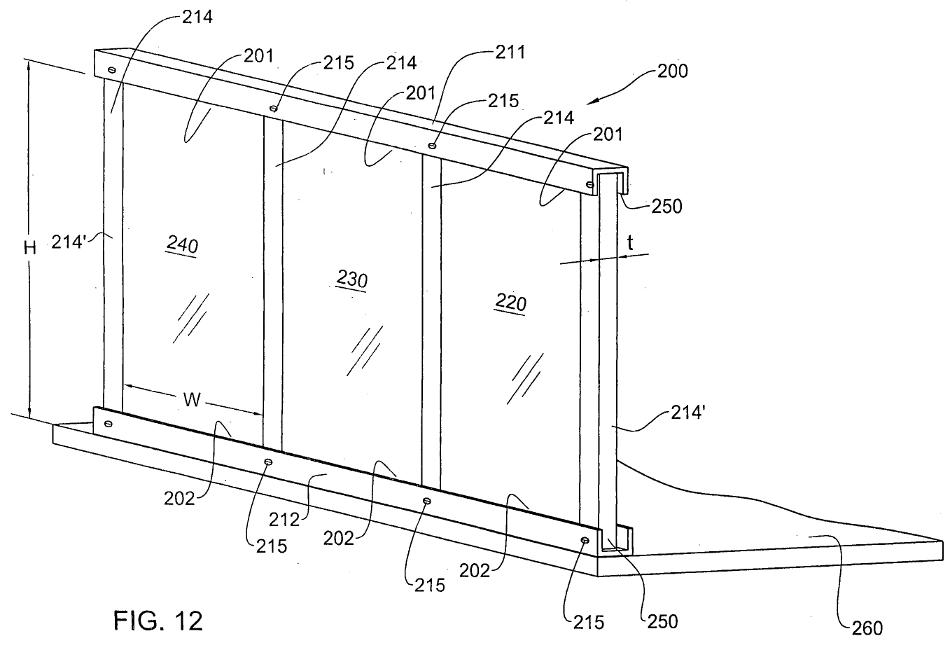

In a third embodiment, and referring to FIG. 12, a panel connector 200 is adapted for connecting a plurality of panels, such as for example end panels 220, 240, and middle panel 230, in series, and optionally to another structure. Of course, the panel connector 200 according to this embodiment may be adapted for connecting one or two panels, or indeed more than three panels. In this embodiment, the panels 220, 230, 240 are of substantially identical height H, and while typically all of the same width, the widths W of the panels may be different one from the other.

The connector 200 comprises a pair of spaced elongate edge connectors 211, 212, each having an edge-receiving track 250, for loosely and slidingly receiving opposed edges 201, 202, respectively, of each of said plurality of panels 220, 230, 240. Each of the panels 220, 230, 240 are typically rectangular and may be similar to those described for the first or second embodiments, mutatis mutandis.

A plurality of edge members 214 are provided in a spaced manner so that each panel is enclosed between a pair of said edge member 214 in the width direction W, and said edge connectors 211, 212 in the height direction H. Thus, the intermediately disposed edge members 214 each operate as edge members for two adjacent panels, while the edge members 214 disposed at the ends of the connector 200 (also designated as 214′) operate as edge members for only one panel each.

The edge members 214 are each connected to the edge connectors 211, 212 by means of any suitable connecting means, such as screws or snap fit connections, similar to those described hereinbefore, mutatis mutandis. Alternatively, the edge members 214 may be connected to the edge connectors 211, 212, via cylindrical pins 215, which, in the absence of said panels could result in the frame connector 200 collapsing under the parallelogram effect, as the edge connectors 211, 214 pivot with respect to the edge members 214. Alternatively, the pins may have different cross-sections, such as oval, polygonal, star-shaped, and so on, and fit into apertures in the frame having complementary cross-sections, helping to prevent the aforementioned collapse when unloaded. However, when the frame is loaded such pins may not be sufficient by themselves to prevent such collapse, in the absence of the said panels.

The edge members may be 214 simple struts, and identical one with the other, or different one from the other. The edge members 214 can have any suitable cross-section, and in the illustrated embodiment the edge members 214 have a rectangular cross-section, of the same thickness t as the panels, so that the free ends of the edge members 214 can be received an secured within the said tracks 250.

Optionally, the edge members 214 may also comprise tracks, similar to tracks 250, to assist in retaining the panels within their respective frames, each frame being defined by a pair of opposed edge members 214 on either side of the particular panel, and a portion of each of one of the edge connectors 211, 212 wherein the edges 201, 202 of the particular panel are trapped.

Further optionally, the edge members 214 that are at the free ends of the frame connector 200, herein designated also as 214′ may be adapted for connecting the same to another structure. For example, such a structure may be another similar frame connector, to be connected in series with the said frame connector 200 by joining the now adjacent free-end edge connectors 214′ of the two frame connectors, for example by screwing or bolting the edge members 214′ together. Alternatively, the free-end edge connectors 214′ may be specially molded to allow two frame connectors 200 to be joined at any desired mutual angle therebetween. For example, the edge connector 214′ of one frame connector 200 may comprise an L-shaped cross-section, wherein one “arm” of the L is facing an edge of the corresponding panel, and the other arm of the L provides an anchoring element for enabling the edge member 214′ of the other connecting frame to be joined thereto, by screwing, bolting and so on. Accordingly, it is possible to connect a plurality of such frame connectors 200 to form an open or a closed polygonal structure, such as a box, for example.

Further optionally, the edge members 214 that are intermediately disposed within the frame connector 200, herein designated also as 214″ may be adapted for connecting the same to another structure. For example, such a structure may be another similar frame connector, to be connected orthogonally or at a different angle with the said frame connector 200 by joining the connector 214″ to the now adjacent free-end edge connectors 214′ of the other frame connectors, for example by screwing or bolting the edge members 214″, 214′ together. Alternatively, the intermediately disposed edge connectors 214″ may be specially molded to allow two frame connectors 200 to be joined in a T-configuration at any desired mutual angle therebetween. For example, the edge connector 214″ of one frame connector 200 may comprise a T-shaped cross-section, wherein the central “arm” of the T is facing an edge of the corresponding panel, and the other two opposed arms of the T provides an anchoring element for enabling the adjacent panels of the frame 200 to be secured.

Similarly, at least one edge connector may be in the form of an “+”, allowing four panels to be secured thereto. Many other forms for the edge connector are possible for enabling interconnection of frames in any desired configuration.

Similarly, one or both of said edge connectors 211, 212 may be adapted for connecting the frame connector 200 to another structure. For example, the lower edge connector 212, as illustrated in FIG. 12, may be adapted for mounting to a floor panel 260, and this may be accomplished in any suitable manner. For example, screws may be used to secure the edge connector 212 to the floor panel 260, or alternatively the edge connector 212 may be glued to the floor panel 260. In a similar manner, the upper edge connector 211 may be adapted for connection to a roof panel (not shown) or any other structure, mutatis mutandis.

Thus, the present invention also relates to a method for designing a load bearing structure having at least one panel and at least one frame circumscribing said panel, comprising:

designing said at least one panel member for bearing a majority of a load to be supported by said structure;

for each said designing said frame for trapping said panel therein and for bearing a minority of said load, wherein substantially no shear stresses are transmittable between said panel and said frame.

### EXAMPLE

A comparative test was performed on a frame (herein after designated A), and on a frame incorporating a panel (herein after designated B) according to the invention.

The frame A was rectangular having four edge members welded together at the corners of the frame, the external dimensions thereof being 590 mm×1840 mm. The frame A comprised a U-shaped cross-section having internal dimensions 10.5 mm (width), and 20 mm (each of the arms of the U). Wall thickness of the U-section was 2.5 mm, and the frame was constructed from metal.

(It should be noted that a frame geometrically similar to frame A but made from plastic rather than metal would generally experience much greater deflections when subjected to the same forces—typically 10 times the deflection that would be experienced by the metal frame.)

The frame-panel B comprised a rectangular frame similar in cross-section to frame A but with wall thickness of 3 mm rather than 2.5 mm, and made from plastic (polypropylene) rather than metal. A panel of dimensions 590 mm×1840 mm and depth 10.5 mm was loosely enclosed within the plastic frame. The panel was made from extruded plastic, and provided by Polygal Ltd, Israel.

Test 1

In this test, the frame A and the frame-panel B were in turn held steady at the base (along the 590 mm dimension), and a shear force of 5 Kg force was applied to the top of the structure. The top of the metal frame A deflected by 12.87 mm with respect to the base, while the deflection for the frame-panel B was 1.23 mm.

Test 2

In this test, the frame A and the frame-panel B were in turn held steady at the base and at the top (along the 590 mm dimensions), and a force of 5 Kg force perpendicular to the plane of the frame was applied at the center point of one edge member (along the 1840 mm dimension). At the point of application of force the metal frame A deflected by 5.08 mm with respect to the plane of the frame, while the deflection for the frame-panel B was 77.45 mm.

Test 3

In this test, the frame A and the frame-panel B were in turn held steady at the base (along the 590 mm dimension), and a vertical longitudinal compressive force of 5 Kg force was applied to the top of the structure. The top of the metal frame A deflected by 0.71 mm towards the base, while the deflection for the frame-panel B was 0.35 mm.

The tests demonstrate that the frame-panel B deflects by less than 10% with respect to metal frame A, when subjected to shear, and by less than 50% when subjected to compressive forces. This corresponds to about 1% for shear and to about 5% for compressive forces when the frame-panel B is compared with a plastic frame (without the panel). Accordingly, the stiffness and buckling load limit of the frame-panel combination according to the invention are much higher than those of the frame by itself, which in turn means that a relatively flexible frame may be used, according to the invention, to entrap the panel—which is thus the main load carrying member—and to enable the panel to be connected to an external structure without having to modify the panel itself. In fact the frame according to the present invention does not even require to be stiff enough to maintain its shape under its own weight, but only that the edge members of the frame are shaped to entrap the edges of the panel therein, and that the edge members do not stretch to the extent that the panel can fall out of the frame. The above considerations apply for compression and shear loads along the plane of the frame or panel. In contrast, Test 2 shows that perpendicular to the plane of the frame, the metal frame A is stiffer than the frame-panel B.

While there has been shown preferred embodiments of the invention, it is to be understood that many changes may be made therein without departing from its essential spirit.

1. A connector for connecting a panel having a plurality of edges to a structure, said connector in the form of a frame comprising at least a corresponding plurality of edge connectors joined one to another such as to enable said edge connectors to circumscribe said edges of a said panel,
wherein at least two of said edge connectors each comprise a channel sized for loosely receiving corresponding edges of a said panel such as to trap a said panel within said frame and such that substantially no shear stresses are transmittable between said frame and a panel that may be accommodated therein; and
wherein at least one said edge connector is adapted for connection to a said structure.

2. A connector according to claim 1, particularly adapted for enabling a substantially rectangular panel to be connected to a structure, comprising:
first and second opposed said edge connectors, each having a channel for slidingly receiving first and second opposed edges, respectively, of a said panel;
third and fourth opposed edge connectors adapted to be aligned with third and fourth opposed edges of said panel;
wherein said first and second edge connectors are orthogonally joined to said third and fourth edge connectors to form said frame;
wherein at least said first and second edge connectors are adapted for connection to a said structure.

3. A connector according to claim 2, wherein said first and second edge connectors are orthogonally joined to said third and fourth edge connectors by means of at least one pin at each of the corners of said frame.

4. A connector according to claim 3, wherein said pins allow pivotal movement between adjacent said edge connectors.

5. A connector according to claim 2, wherein said first and second edge connectors are orthogonally joined to said third and fourth edge connectors by means of at least one screw screwed at each of the corners of said frame.

6. A connector according to claim 2, wherein at least one of said first edge connector and said second connector form part of another said frame and comprise a further said channel for accommodating a corresponding edge of another said panel.

7. A connector according to claim 2, wherein at least one of said first edge connector and said second connector are adapted for connecting said frame directly to a sheet of material.

8. A connector according to claim 2, wherein said channels are substantially of rectangular cross-section and sized to provide a lateral clearance of about 1 mm between a said panel accommodated in said frame and said channel.

9. A connector according to claim 2, wherein said third and fourth edge connectors are adapted for resisting tensile stresses less than about 500 kg force per m² for loads within the elastic limit thereof.

10. A connector according to claim 2, wherein said third and fourth edge connectors are incapable of resisting compressive loads in direction parallel to said edges.

11. A connector according to claim 1, wherein at least one of:
mechanical properties of said edge connectors; and
a manner in which said edge connectors are joined to form said frame;
are such that the frame, in the absence of a said panel accommodated therein, is able to support buckling loads which are no greater than x % of corresponding buckling loads of said frame when accommodating a said panel therein, wherein x % is between about 0.5% and 20%, and typically less than about 5%.

12. A connector according to claim 1, wherein at least one of:
mechanical properties of said edge connectors; and
a manner in which said edge connectors are joined to form said frame;
are such that the frame, in the absence of a said panel accommodated therein, has a stiffness no greater than y % of the corresponding modulus of said frame when accommodating a said panel therein, wherein y % is between about 0.5% and 20%, and typically less than about 5%.

13. A load bearing structure, comprising:
a panel having a plurality of edges;
a frame comprising at least a corresponding plurality of edge connectors joined one to another such as to enable said joined edge connectors to circumscribe said edges of said panel,
wherein at least two of said edge connectors each comprise a channel sized for loosely receiving corresponding edges of said panel such as to trap said panel within said frame and such that substantially no shear stresses are transmittable between said frame and said panel; and
wherein at least one said edge connector is adapted for connection to an external structure.

14. A load bearing structure according to claim 13, wherein said panel comprises a substantially rectangular planform, wherein said frame comprises:
first and second opposed said edge connectors, each having a channel for slidingly receiving first and second opposed edges, respectively, of said panel;
third and fourth opposed edge connectors adapted to be aligned with third and fourth opposed edges of said panel;
wherein said first and second edge connectors are orthogonally joined to said third and fourth edge connectors to form said frame;
wherein at least said first and second edge connectors are adapted for connection to said external structure.

15. A load bearing structure according to claim 14, wherein said first and second edge connectors are orthogonally joined to said third and fourth edge connectors by means of at least one pin at each of the corners of said frame.

16. A load bearing structure according to claim 15, wherein said pins allow pivotal movement between adjacent said edge connectors.

17. A load bearing structure according to claim 14, wherein at least one of said first edge connector and said second connector form part of another said frame and comprise a further said channel for accommodating a corresponding edge of another said panel of another said load bearing structure.

18. A load bearing structure according to claim 14, wherein at least one of said first edge connector and said second connector are adapted for connecting said frame directly to a sheet of material.

19. A load bearing structure according to claim 14, wherein said channels are substantially of rectangular cross-section and sized to provide a lateral clearance of about 0.5 mm between a said panel accommodated in said frame and said channel.

20. A load bearing structure according to claim 14, wherein said third and fourth edge connectors are adapted for resisting stresses loads less than about 500 Kgforce per m² for loads within the elastic limit thereof.

21. A load bearing structure according to claim 14, wherein said third and fourth edge connectors are incapable of resisting compressive loads in direction parallel to said edges.

22. A load bearing structure according to claim 14, wherein said first and second edge connectors are orthogonally joined to said third and fourth edge connectors by means of at least one screw screwed at each of the corners of said frame.

23. A load bearing structure according to claim 13, wherein at least one of:
mechanical properties of said edge connectors; and
a manner in which said edge connectors are joined to form said frame;
are such that the frame, in the absence of a said panel accommodated therein, is able to support buckling loads which are no greater than x % of corresponding buckling loads of said frame when accommodating a said panel therein, wherein x % is between about 0.5% and 20%, and typically less than about 5%.

24. A load bearing structure according to claim 13, wherein at least one of:
mechanical properties of said edge connectors; and
a manner in which said edge connectors are joined to form said frame;
are such that the frame, in the absence of a said panel accommodated therein, has an elastic modulus no greater than y % of the corresponding modulus of said frame when accommodating a said panel therein, wherein y % is between about 0.5% and 20%, and typically less than about 5%.

25. A load bearing structure according to claim 13, wherein said panel is adapted to support a major proportion of loads applied to said structure, and wherein said frame is adapted to support a minor proportion of said loads, said loads being applied substantially in a plane co-planar with said panel.

26. A load bearing structure according to claim 13, comprising a plurality of said panels interconnected via at least some of said edge connectors.

27. A load bearing structure according to claim 13, wherein said frame is made from a molded material.

28. A load bearing structure according to claim 27, wherein said molded material is a plastic material.

29. A load bearing structure according to claim 13, wherein said panel is made from an extruded material.

30. A load bearing structure according to claim 29, wherein said extruded material is a plastic material.

31. A method for designing a load bearing structure having at least one panel and at least one frame circumscribing said panel, comprising:
designing said at least one panel member for bearing a majority of a load to be supported by said structure;
for each said panel, designing said frame for trapping said panel therein and for bearing a minority of said load, wherein substantially no shear stresses are transmittable between said panel and said frame.
